(19) United States
(12) Patent Application Publication
(10) Pub. No.: US 2021/0316162 A1
(43) Pub. Date: Oct. 14, 2021

(54) EMERGENCY OXYGEN SYSTEM FOR AIRCRAFT PASSENGERS

(71) Applicant: B/E Aerospace Systems GmbH, Lubeck (DE)

(72) Inventors: Christian Krausholz, Lubeck (DE); Detlev Degenhardt, Stockelsdorf (DE)

(73) Assignee: B/E Aerospace Systems GmbH, Lubeck (DE)

(21) Appl. No.: 17/222,452

(22) Filed: Apr. 5, 2021

(30) Foreign Application Priority Data
Apr. 9, 2020 (DE) 102020204596.8

(51) Int. Cl. A62B 7/14; B64D 11/00; A62B 9/00

(52) U.S. Cl. CPC A62B 7/14; B64D 2231/025; A62B 9/00; B64D 11/00

(57) ABSTRACT

The present disclosure relates to an emergency oxygen system (1) for an aircraft passenger with
an oxygen mask (7),
a controllable oxygen feed for the oxygen mask (7), and
a control unit (5) for the control of the oxygen feed to the oxygen mask (7),
   wherein the control unit (5) is configured to control the oxygen feed in a manner such that a demand oxygen pulse (21) flows into the oxygen mask (7) if a draw of breath (20) of the aircraft passenger is registered and that safety oxygen pulses (23) regularly flow into the oxygen mask (7) if no draw of breath of the aircraft passenger has been registered within a certain time window (T).

The present disclosure relates to an emergency oxygen system for an aircraft passenger and to a method for controlling the oxygen feed for an oxygen mask of an emergency oxygen system for an aircraft passenger, in particular for the overhead positioning above seating rows in a passenger aircraft.

Usually, oxygen masks are provided above the seats below the overhead storage compartments, for the emergency oxygen supply of passengers of an aircraft, for example given a sudden pressure drop in the cabin, said masks in the case of an emergency dropping out of the cabin ceiling and supplying the passengers with oxygen from a central or decentral oxygen supply.

It is known to regulate the oxygen feed into an oxygen mask according to requirements in the case of an emergency. The breathing-in of a passenger given a worn oxygen mask herein generates a slight underpressure in the oxygen mask and this is registered, whereupon an oxygen pulse into the mask is activated, such being able to be inhaled by the passenger. The higher the breathing frequency of the passenger, the more pulses of oxygen are provided for the passenger, in order on the one hand to match the oxygen demand, but on the other hand not to provide oxygen when it is not used, such as during exhalation.

However, it becomes a problem when the slight underpressure in the oxygen mask which is to be registered is not achieved, so that no draw of breath is registered and accordingly no oxygen pulse is activated.

This could happen for example if the oxygen mask is not put on correctly and surrounding air flows into the oxygen mask on breathing in, so that no underpressure is built up. The probability of such a scenario is greater with small children and babies, concerning whom for several reasons on the one hand the probability of a non-optimal sitting of the oxygen mask is basically higher and on the other hand the registration of the breathing which is basically more shallow when compared to adults is more difficult.

For solving this problem, EP 2 152 578 B1 suggests either supplying the oxygen masks with oxygen in dependence on the altitude in a demand-controlled operating mode, or with oxygen in a permanent manner, wherein a reservoir bag is filled with oxygen, to which bag the oxygen mask is connected.

The disadvantage with the solution of EP 2 152 578 B1 is the fact that a reservoir bag is necessary, in order to buffer the oxygen given a permanent supply of oxygen, in order on the one hand for this not to escape without being used and on the other hand for it to be available when the passenger breathes in. Furthermore, concerning EP 2 152 578 B1, it is disadvantageous that given an incorrectly sitting mask, an oxygen supply is not ensured at every altitude.

In contrast, the emergency oxygen system and method which are disclosed herein provide an adequate oxygen supply at each flight altitude, even with a poorly sitting mask, wherein no reservoir bag is necessary.

According to a first aspect of the present disclosure, an emergency oxygen system for an aircraft passenger is provided, with
an oxygen mask,
a controllable oxygen feed for the oxygen mask, and
a control unit for the control of the oxygen feed to the oxygen mask,
   wherein the control unit is configured to control the oxygen feed in a manner such that a demand oxygen pulse flows into the oxygen mask when a draw of breath of the aircraft passenger is registered and that safety oxygen pulses regularly flow into the oxygen mask when no draw of breath of the aircraft passenger has been registered within a certain time window.

The emergency oxygen system which is disclosed here thus not only uses the registration of a draw of breath of an aircraft passenger for the demand-orientated oxygen feed, but simultaneously in the same operating mode uses the information of a non-registration of a draw of breath of an aircraft passenger within a certain time window as an activator, in order to regularly output safety oxygen pulses into the oxygen mask. By way of this, it is ensured that even with a poorly sitting mask and a very shallow breathing, oxygen is regularly present in the oxygen mask and this can be breathed in by the aircraft passenger. Due to the regular delivery of safety oxygen pulses, the oxygen mask can itself function as an oxygen buffer, so that a reservoir bag as in the state of the art given a permanent oxygen supply is not necessary.

The altitude or the cabin pressure plays no part in the control as to whether the demand oxygen pulse or safety oxygen pulse are delivered. The altitude and/or the cabin pressure however can optionally be included on evaluating the period of the safety oxygen pulses and/or the oxygen quantity per safety oxygen pulse. The greater the altitude or the lower the cabin pressure, the more frequent and/or greater can the safety oxygen pulses be.

Optionally, the time window can have defined length and can reset by way of an activating of the emergency oxygen system as well as by way of a demand oxygen pulse. Hence not only can one examine whether no draw of breath within a time window is registered at the beginning after the activation of the emergency oxygen system, but also after each registered draw of breath. The time window can preferably be set such that no safety oxygen pulse needs to be delivered given a normal breathing frequency with registerable draws of breath. For example, the time window can be 10 seconds, since one can expect that a draw of breath would need to be registered within 10 seconds. If however after 10 seconds no draw breath has been registered, then the regular delivery of safety oxygen pulses starts.

Optionally, the control unit can be configured to control the oxygen feed in a manner such that after completion of the time window, safety oxygen pulses regularly flow into the oxygen mask until a draw of breath of the aircraft passenger is registered. The regular delivery of safety oxygen pulses is herein only stopped by way of the registration of a draw of breath of the aircraft passenger, whereupon a demand oxygen pulse is delivered.

Optionally, the time window can be longer than a period of the regular safety oxygen pulses. The periods of the regular safety oxygen pulses can be for example 4 seconds, which roughly corresponds to an expected breathing frequency of 15 draws of breath. Herewith, it is probable that oxygen for breathing in is provided in the oxygen mask at least with each second non-registered draw of breath of the aircraft passenger. In order to increase the probability of oxygen being provided in the oxygen mask for breathing given a non-registered draw of breath of the aircraft passenger, the period of the regular safety oxygen pulses can be shortened, thus be for example only 2 seconds. In order herein not to increase the total delivery of oxygen due to the regular safety oxygen pulses, the oxygen quantity per safety oxygen pulse can accordingly be reduced, thus for example be only 50% of a normal safety oxygen pulse.

Optionally, a demand oxygen pulse can comprise a greater oxygen quantity than a safety oxygen pulse. By way of this, one avoids too large a quantity of oxygen being provided, such not being inhaled. In the case of a demand oxygen pulse, it is ensured that the oxygen is indeed breathed in, whereas a safety oxygen pulse to all probability is not breathed in. However, one can also assume that non-registered draws of breath have less oxygen demand than registered draws of breath. For example, in the case of a child or baby whose draws of breath are not registered, the oxygen demand is lower than with an adult.

As already mentioned previously, the control unit can optionally be configured to control the oxygen feed in a manner such that the period of the safety oxygen pulse and/or the oxygen quantity per safety oxygen pulse depends on the altitude or the cabin pressure. Herewith, the oxygen delivery via the safety oxygen pulse is adapted to the generally emergency demand. The higher the altitude or the lower the cabin pressure, the higher is the oxygen demand which cannot be covered by the cabin air, so that the safety oxygen pulses can be accordingly be more frequent and/or larger.

According to a second aspect of the present disclosure, a method for the control of the oxygen feed for an oxygen mask of an emergency oxygen system for air aircraft passenger is provided, with the steps:
feeding a demand oxygen pulse into the oxygen mask if a draw of breath of the aircraft passenger is registered and
feeding regular safety oxygen pulses into the oxygen mask if no draw of breath of the aircraft passenger has been registered within a certain time window.

Optionally, the time window can have a certain length and start afresh by way of activating an emergency oxygen system as well as by a demand oxygen pulse.

Optionally, after the completion of the time window, safety oxygen pulses can be regularly feed to the oxygen mask until a draw of breath of the aircraft passenger is registered.

Optionally, the time window can be longer than a period of the regular safety oxygen pulses.

Optionally, a demand oxygen pulse can comprise a greater oxygen quantity than a safety oxygen pulse.

Optionally, the period of the safety oxygen pulses and/or the oxygen quantity per safety oxygen pulse can be dependent on the altitude or the cabin pressure.

According to a third aspect of the present disclosure, a computer-readable medium is provided, with stored instructions for carrying out the aforementioned method. The method can therefore be carried out on a computer by software, according to whose instructions the control unit is operated.

The disclosure is hereinafter explained in more detail by way of embodiment examples which are represented in the drawings. There are shown in:

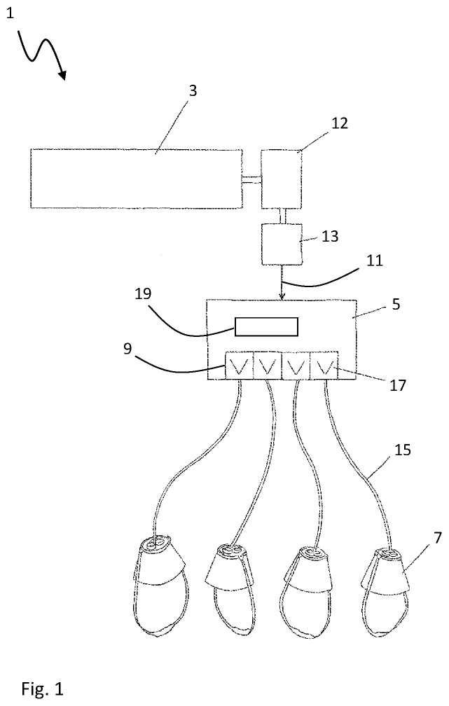

FIG. 1 a schematic view of the components of an exemplary emergency oxygen system with a control unit, according to the present disclosure; and

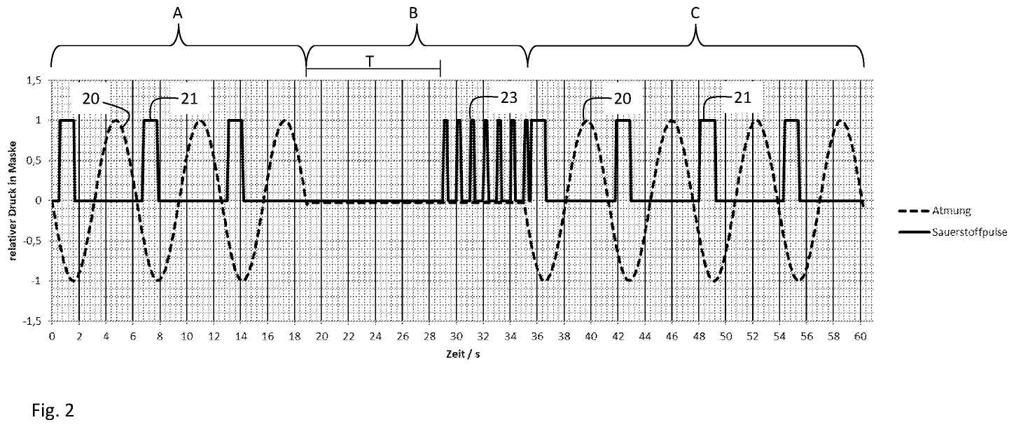

FIG. 2 a diagram of the oxygen flow into the emergency oxygen masks as a function over time on the basis of the breathing and the oxygen feed, according to an exemplary embodiment of the control method which is disclosed herein.

Components of an emergency oxygen system 1 are shown in FIG. 1, with which system, in the case of an aircraft cabin pressure loss, aircraft passengers can be supplied with oxygen over a certain time period whilst the aircraft is at altitudes, at which the surrounding air pressure does not ensure an adequate oxygen supply of the aircraft passengers. The emergency oxygen system 1 comprises an oxygen pressure tank 3 which comprises breathing gas which is enriched with oxygen compressed under pressure. Alternatively or additionally, a chemical oxygen generator with a buffer container device could also be provided in the emergency oxygen system 1, in order to generate oxygen when required.

The emergency oxygen system 1 further comprises a control unit 5 and four emergency oxygen masks 7. The control unit 5 comprises a distribution module 9 which with a pipe-like or tube-like fluid connection 11 is connected to the oxygen pressure tank 3, wherein the flow of oxygen through the fluid connection 11 can be adjusted by a shut-off element 12 and a regulation valve 13. The four emergency oxygen masks 7 are each connected with a tube-like fluid connection 15 to the distribution module 9 of the control unit 5. The oxygen feed into the respective tube-like fluid connection 15 is controlled via an electrically controllable valve 17 in the distribution module 9. The control unit 5 further comprises control electronics 19 for the control of the valves 17.

In FIG. 2 it is shown how the control unit 5 regulates the oxygen flow into the emergency oxygen masks 7. The relative pressure in the respective emergency oxygen mask 7 here is plotted over time in seconds on an arbitrary scale. In a first time section A, draws of breath 20 of a passenger who breathes through one of the emergency oxygen masks 7 lead to a relative pressure fluctuation in the respective emergency oxygen mask 7 (see dashed line). This pressure fluctuation is registered by the control unit 5 and a demand oxygen pulse 21 is delivered (see unbroken line) when the relative pressure in the emergency oxygen mask 7 drops below a threshold and/or the rate of the pressure drop falls below a threshold.

If however no draw of breath 20 is registered in a second time section B, then safety oxygen pulses 23 are regularly delivered after a certain time window T. The frequency of the safety oxygen pulses 23 here is more than five times higher than the typical frequency of the demand oxygen pulses 21. The pulse duration of the safety oxygen pulses 23 in contrast is less than half the pulse duration of the demand oxygen pulses 21. Herewith, on the one hand the probability of enough oxygen being available in the emergency oxygen mask 7 given a non-registered draw of breath is increased, but on the other hand oxygen for the safety oxygen pulses 23 is not unnecessarily wasted if there is little or even no breathing demand. The time window T here at approx. 10 seconds is selected larger than the typical period duration of the demand oxygen pulses 21, so that no safety oxygen pulses 23 are delivered between normally registered draws of breath 20.

The safety oxygen pulses 23 are delivered until a breath is again registered 20. In a third time section C, demand oxygen pulses 21 which are activated by way of registered draws of breath 20 are again delivered.

The numbered indications of the components or movement directions as “first”, “second”, “third” etc. have herein been selected purely randomly so as to differentiate the components or the movement directions amongst one another, and can also be selected in an arbitrarily different manner. Hence these entail no hierarchy of significance.

Equivalent embodiments of the parameters, components or functions which are described herein and which appear to be evident to a person skilled in the art in light of this description are encompassed herein as if they were explicitly described. Accordingly, the scope of the protection of the claims is also to include equivalent embodiments. Features which are indicated as optional, advantageous, preferred, desired or similarly denoted “can”-features are to be understood as optional and as not limiting the protective scope.

The described embodiments are to be understood as illustrative examples and no not represent an exhaustive list of possible alternatives. Every feature which has been disclosed within the framework of an embodiment can be used alone or in combination with one or more other features independently of the embodiment, in which the features have been described. Whilst at least one embodiment is described and shown herein, modifications and alternative embodiments which appear to be evident to a person skilled in the art in the light of this description are included by the protective scope of this disclosure. Furthermore the term “comprise” herein is neither to exclude additional further features or method steps, nor does “one” exclude a plurality.

### LIST OF REFERENCE NUMERALS

1 emergency oxygen system
3 oxygen pressure tank
5 control unit
7 emergency oxygen masks
9 distribution module
11 fluid connection
17 valves
19 control electronics
20 draws of breath
21 demand oxygen pulses
23 safety oxygen pulses
T time window
A first time section
B second time section
C third time section

1. An emergency oxygen system (1) for an aircraft passenger, with
an oxygen mask (7),
a controllable oxygen feed for the oxygen mask (7), and
a control unit (5) for the control of the oxygen feed to the oxygen mask (7),
wherein the control unit (5) is configured to control the oxygen feed in a manner such that a demand oxygen pulse (21) flows into the oxygen mask (7) if a draw of breath (20) of the aircraft passenger is registered and that safety oxygen pulses (23) regularly flow into the oxygen mask (7) if no draw of breath of the aircraft passenger has been registered within a certain time window (T).

2. An emergency oxygen system (1) according to claim 1, wherein the time window (T) has a defined length and resets by way of an activating of the emergency oxygen system (1) as well as by a demand oxygen pulse (21).

3. An emergency oxygen system (1) according to claim 1 or 2, wherein the control unit (5) is configured to control the oxygen feed in a manner such that after completion of the time window (T), safety oxygen pulses (23) regularly flow into the oxygen mask (7) until a draw of breath of the aircraft passenger is registered.

4. An emergency oxygen system (1) according to one of the preceding claims, wherein the time window (T) is longer than a period of the regular safety oxygen pulses.

5. An emergency oxygen system (1) according to one of the preceding claims, wherein a demand oxygen pulse (21) comprises a greater oxygen quantity than one of the safety oxygen pulse (23).

6. An emergency oxygen system (1) according to one of the preceding claims, wherein the control unit is configured to control the oxygen feed in a manner such that the period of the safety oxygen pulse (23) and/or the oxygen quantity per safety oxygen pulse (23) depends on the altitude or the cabin pressure.

7. A method for the control of the oxygen feed for an oxygen mask (7) of an emergency oxygen system (1) for air aircraft passenger, with the steps:
feeding a demand oxygen pulse (21) into the oxygen mask (7) if a draw of breath (20) of the aircraft passenger is registered and
feeding regular safety oxygen pulses (23) into the oxygen mask (7) if no draw of breath of the aircraft passenger has been registered within a certain time window (T).

8. A method according to claim 7, wherein the time window (T) has a certain length and resets by way of activating an emergency oxygen system (1) as well as by way of a demand oxygen pulse.

9. A method according to claim 7 or 8, wherein after the completion of the time window (T), safety oxygen pulses (23) are regularly feed to the oxygen mask (7) until a draw of breath (20) of the aircraft passenger is registered.

10. A method according to one of the claims 7 to 9, wherein the time window (T) is longer than a period of the regular safety oxygen pulses.

11. A method according to one of the claims 7 to 10, wherein a demand oxygen pulse (21) comprises a greater oxygen quantity than one of the safety oxygen pulses (23).

12. A method according to one of the claims 7 to 11, wherein the period of the safety oxygen pulses (23) and/or the oxygen quantity per safety oxygen pulse (23) is dependent on the altitude or the cabin pressure.

13. A computer-readable medium with stored instructions for carrying out the method according to one of the claims 7 to 12.
